(19) United States
(12) Patent Application Publication
(10) Pub. No.: US 2024/0101812 A1
(43) Pub. Date: Mar. 28, 2024

(54) Laser Weldable Polyester Composition

(71) Applicant: Celanese International Corporation, Irving, TX (US)

(72) Inventor: Mingyue Li, Shanghai (CN)

(21) Appl. No.: 18/262,418

(22) PCT Filed: Jan. 21, 2021
(86) PCT No.: PCT/CN2021/073041

§ 371 Date: Jul. 21, 2023

(51) Int. Cl. C08L 67/02

(52) U.S. Cl. CPC C08L 67/02; C08L 2205/025; C08L 2205/03

(57) ABSTRACT

Polyester polymer compositions are described containing a blend of different polyester polymers. The different polyester polymers are combined with one or more laser additives for producing polymer articles that have excellent laser weldable characteristics. The polymer composition can also contain reinforcing fibers and a lubricant. In one aspect, the laser additive is a carbonaceous material alone or in combination with a quinoline.

### BACKGROUND

Engineering thermoplastics and elastomeric materials are often used in numerous and diverse applications in order to produce molded parts and products. For instance, polyester polymers and polyester elastomers are used to produce all different types of molded products, such as injection molded products, blow molded products, and the like. Polyester polymers, for instance, can be formulated in order to be chemically resistant, to have excellent strength properties and, when formulating compositions containing polyester elastomers, to be flexible. Of particular advantage, polyester polymers can be melt processed due to their thermoplastic nature. In addition, polyester polymers can be recycled and reprocessed.

Polyester polymers are particularly well suited to producing molded articles of any suitable shape or dimension. The molded articles can be made through injection molding, thermoforming, or any other suitable melt processing method. In many applications, the molded article is then bonded to adjacent materials when incorporated into a product or system. Bonding can occur through the use of an adhesive, the use of ultrasonic energy, or using a mechanical fastener. In certain applications, laser welding is the preferred method for bonding or attaching two parts together. The use of laser welding is not only relatively simple but is also very precise and does not typically cause any structural damage to the parts.

Polyester polymers, however, are not well suited for use in laser welding applications. Polybutylene terephthalate resins, for instance, have low transmittance to laser beams and therefore do not normally produce a viable weld.

In this regard, in the past, various different additives and components were combined with polyester polymers, particularly polybutylene terephthalate resins, in order to produce a polymer composition that was laser weldable. For example, polycarbonate resins were commonly combined with polybutylene terephthalate polymers. In addition, the properties of the polybutylene terephthalate polymer were varied by introducing additional comonomers into the polymer chain. Unfortunately, many of the components combined with the polybutylene terephthalate resin had a tendency to degrade one or more mechanical properties of the resulting polymer composition or products made from the composition.

In view of the above, a need currently exists for a polymer composition containing a polybutylene terephthalate resin that displays excellent laser weldability and high welding strength. A need also exists for molded articles made from the polybutylene terephthalate polymer composition that has good flow properties and excellent mechanical properties.

### SUMMARY

In general, the present disclosure is directed to polyester polymer compositions containing a blend of polyester polymers that are laser weldable. The present disclosure is also directed to a laser weldable polybutylene terephthalate polymer composition that has a darker color and has carefully controlled laser transmission properties.

For example, in one embodiment, the present disclosure is directed to a laser weldable composition comprising a mixture of a first polyester polymer and a second polyester polymer. The first polyester polymer can have a different crystallization rate than the second polyester polymer. For instance, the first polyester polymer can be a polybutylene terephthalate polymer while the second polyester polymer can be a polyethylene terephthalate polymer. The first polyester polymer can be present in the composition in an amount from about 30% by weight to about 60% by weight, such as in an amount from about 40% by weight to about 50% by weight. The second polyester polymer, on the other hand, can be present in the polymer composition in an amount from about 12% by weight to about 30% by weight, such as in an amount from about 18% by weight to about 28% by weight. Overall, the polymer composition can contain one or more polyester polymers in an amount of from about 55% by weight to about 75% by weight, such as in an amount from about 60% by weight to about 70% by weight.

The laser weldable composition further contains reinforcing fibers and a laser additive. The reinforcing fibers can be present in the polymer composition generally in an amount from about 12% by weight to about 42% by weight, such as in an amount from about 25% by weight to about 38% by weight. The reinforcing fibers can comprise glass fibers. In one embodiment, the glass fibers have a flat profile, such as a ribbon-like shape. The laser additive, on the other hand, can be contained in a masterbatch combined with a carrier polymer. The laser additive can comprise a carbonaceous material, such as carbon black, graphite, or mixtures thereof. The carbonaceous material can have an intrinsic thermal conductivity of about 40 W/m-K or more. The carbonaceous material can be present in the polymer composition generally in an amount from about 0.1% by weight to about 0.8% by weight. The carrier polymer, on the other hand, can be a polyester polymer, such as a polybutylene terephthalate polymer. In one aspect, a second laser additive can be contained in the masterbatch comprising a quinoline.

In one aspect, the laser weldable composition can further contain a lubricant. The lubricant can be an ester of one or more carboxylic acids. For example, the lubricant can be an ester of a montanic acid. The lubricant can further contain a polyol. The lubricant can be present in the polymer composition in an amount from about 0.05% by weight to about 4.8% by weight.

The laser weldable composition made according to the present disclosure can display not only high transmission values, but can also display a uniform transmission property from location to location on a molded article made from the composition. When tested at a wavelength of 980 nm and at a thickness of 1 mm, for instance, the polymer composition of the present disclosure can display a transmission of greater than about 40%, such as greater than about 50%, such as greater than about 55%, such as greater than about 60%, such as greater than about 65%, and generally less than about 95%.

Even at the above transmission values, the polymer composition can also have excellent flow properties. For instance, the polymer composition can have a melt flow rate of greater than about 5 g/10 min, such as greater than about 10 g/10 min, such as greater than about 12 g/10 min, and generally less than about 30 g/10 min, such as less than about 20 g/10 min.

The present disclosure is also directed to articles molded from the polymer composition of the present disclosure. For example, in one embodiment, the present disclosure is directed to an assembly including a molded article made from the polymer composition that has been laser welded to an adjacent component. In one embodiment, the molded article can be a housing for numerous and different products. In one embodiment, the molded article is a housing. The housing can be for an electrical power system. The housing can be for a sensor. The sensor, for instance, can be used in an advanced driver assistance system.

The present disclosure is also directed to a method for attaching a polymer article to an adjacent surface. The method includes contacting a molded article made from the laser weldable composition as described above with a laser beam. The laser beam causes a localized temperature increase within the polymer composition sufficient for the polymer composition to flow and form a weld.

Other features and aspects of the present disclosure are discussed in greater detail below.

### DETAILED DESCRIPTION

It is to be understood by one of ordinary skill in the art that the present discussion is a description of exemplary embodiments only and is not intended as limiting the broader aspects of the present disclosure.

The present disclosure is generally directed to a polymer composition containing polyester polymers that is laser weldable. The different components are selected, for instance, in order to produce a polymer composition that not only has optimal light transmission properties for laser welding, but also has other physical properties making the composition well suited to producing all different types of molded articles. In general, the laser weldable composition of the present disclosure contains a mixture of polyester polymers in combination with reinforcing fibers and at least one laser additive. The laser additive can be added as a masterbatch combined with a carrier polymer. Each component selected for use in the polymer composition contributes to improving the laser weldable properties of the polymer composition, a physical property of the composition, or a property related to facilitating melt processing of the composition.

The polymer composition of the present disclosure includes a combination of polyester polymers that represent the primary components of the composition. For instance, one or more polyester polymers are present in the polymer composition in an amount greater than about 50% by weight, such as in an amount greater than about 55% by weight, such as in an amount greater than about 60% by weight, such as in an amount greater than about 65% by weight, and generally in an amount less than about 80% by weight, such as in an amount less than about 75% by weight, such as in an amount less than about 70% by weight. The polyester polymers are combined with at least one laser additive that greatly enhances the laser transmission properties of the composition. Not only does the polymer composition produce molded articles having relatively high light transmission properties, but also produces molded articles having uniform light transmission properties. For example, in the past, the light transmission properties of molded articles varied over the surface of the article, especially in relation to the gate location (e.g. the location on the molded article where the polymer flowed into the mold). Molded articles made according to the present disclosure, however, can have light transmission properties that vary by no more than about 40% from location to location, such as by no more than about 35%, such as no more than about 30%, such as no more than about 25%, such as even no more than about 25%. Polymer compositions made in the past, on the other hand, produced injection molded articles where the light transmission properties varied by greater than 50%, such as by greater than 60% from one location to another.

Molded articles made according to the present disclosure also have relatively high light transmission properties. For example, when tested at a light wavelength of 980 nm and at a thickness of 1 mm, the polymer composition of the present disclosure can produce molded articles having a light transmission of greater than about 40%, such as greater than about 50%, such as greater than about 55%, such as greater than about 60%, such as greater than about 65%. The light transmission properties are generally less than about 95%, such as less than about 85%, such as less than about 80%.

In one particular embodiment, the polymer composition contains a first polyester polymer that has a faster crystallization rate than a second polyester polymer. The first polyester polymer, for instance, may comprise a polybutylene terephthalate polymer while the second polymer may comprise a polyethylene terephthalate polymer. For example, the polybutylene terephthalate polymer may have a faster crystallization rate and may have an overall higher crystallinity than the polyethylene terephthalate polymer.

Combining a polyester polymer having a faster crystallization rate than a second polyester polymer may provide various advantages and benefits. For instance, using different polyester polymers can be used to produce an overall polymer composition having desired flow properties for use in producing molded articles, particularly injected molded articles. In addition, the selection of the polyester polymers can facilitate dispersion of one or more laser additives contained in the composition.

The relative amounts of the first polyester polymer having the higher crystallinity (such as a polybutylene terephthalate polymer) and the second polyester polymer having the lower crystallinity (such as a polyethylene terephthalate polymer) can vary depending upon numerous factors including the end use application. In one embodiment, for instance, the first polyester polymer may be present in greater amounts than the second polyester polymer. For example, the weight ratio between the first polyester polymer and the second polyester polymer can be from about 1:1 to about 10:1, such as from about 1:25:1 to about 4:1, such as from about 1.5:1 to about 3:1.

In one aspect, the polymer composition can contain the first polyester polymer, such as one or more polybutylene terephthalate polymers, generally in an amount of from about 30% by weight to about 60% by weight, including all increments of 1% by weight therebetween. The composition can contain a single polybutylene terephthalate polymer or can include a plurality of different polybutylene terephthalate polymers having different characteristics. In one aspect, the polymer composition contains one or more polybutylene terephthalate polymers in an amount greater than about 35% by weight, such as in an amount greater than about 40% by weight, and generally in an amount less than about 55% by weight, such as in an amount less than about 50% by weight.

In one particular embodiment, the polymer composition can contain two different polybutylene terephthalate polymers. The two polybutylene terephthalate polymers may differ by viscosity, molecular weight (weight average or number average), polydispersity (MW/Mn), or the like. For example, the polymer composition can contain a first polybutylene terephthalate polymer that has a higher intrinsic viscosity than a second polybutylene terephthalate polymer. The first polybutylene terephthalate polymer, for instance, can have an intrinsic viscosity of greater than about 1 dl/gr, such as greater than about 1.1 dl/gr, such as greater than about 1.2 dl/gr, such as greater than about 1.3 dl/gr. The second polybutylene terephthalate polymer, on the other hand, can have an intrinsic viscosity of less than about 1 dl/gr, such as less than about 0.9 dl/gr, such as less than about 0.85 dl/gr, such as less than about 0.8 dl/gr. Intrinsic viscosity is measured according to ISO Test 1628. The first and second polybutylene terephthalate polymers can be present in the polymer composition at a weight ratio of from about 1:2 to about 2:1, such as from about 1:1.5 to about 1.5:1.

The polymer composition can contain the second polyester polymer, such as a polyethylene terephthalate polymer, generally in an amount greater than about 10% by weight, such as in an amount greater than about 12% by weight, such as in an amount greater than about 15% by weight, such as in an amount greater than about 18% by weight, such as in an amount greater than about 20% by weight. The second polyester polymer is generally present in an amount less than about 33% by weight, such as in an amount less than about 28% by weight, such as in an amount less than about 25% by weight.

In addition to a blend of polyester polymers, the polymer composition of the present disclosure also contains one or more laser additives. The laser additives provide the composition with a dark color and increase the laser transmission properties of the composition. In one aspect, the one or more laser additives are present in a masterbatch that is then added to the polyester polymers. The masterbatch, for instance, can contain one or more laser additives preblended with a carrier polymer. The carrier polymer can comprise any polymer capable of dispersing the one or more laser additives and which is compatible with the blend of polyester polymers contained in the composition. In one embodiment, for instance, the carrier polymer can be a polyester polymer, such as a polybutylene terephthalate polymer, a polyethylene terephthalate polymer, or a copolyester elastomer.

A laser additive that can be incorporated into the polymer composition can be a carbonaceous material. The carbonaceous material, for instance, can be carbon black, graphite, expanded graphite, carbon nanotubes, and mixtures thereof.

The carbonaceous material contained in the polymer composition can generally have a high specific surface area and can be in the form of particles. The specific surface area may be, for example, about 0.5 m²/g or more, in some embodiments about 1 m²/g or more, and in some embodiments, from about 2 to about 40 m²/g. The specific surface area can be determined according to standard methods such as by the physical gas adsorption method (B.E.T. method) with nitrogen as the adsorption gas, as is generally known in the art and described by Brunauer, Emmet, and Teller (J. Amer. Chem. Soc., vol. 60, February, 1938, pp. 309-319). The particulate material may also have a powder tap density of from about 0.2 to about 1.0 g/cm³, in some embodiments from about 0.3 to about 0.9 g/cm³, and in some embodiments, from about 0.4 to about 0.8 g/cm³, such as determined in accordance with ASTM B527-15.

The carbonaceous material also has a high intrinsic thermal conductivity, such as about 40 W/m-K or more, in some embodiments about 70 W/m-K or more, and in some embodiments, about 130 W/m-K or more.

The carbonaceous material has an average size (e.g., diameter) of about 1 to about 100 micrometers, in some embodiments from about 10 to about 90 micrometers, in some embodiments from about 20 to about 80 micrometers, and in some embodiments, from about 30 to about 60 micrometers. In certain embodiments, the carbonaceous material may be in the form of individual platelets having the desired size.

The carbonaceous material can be generally present in the composition in an amount greater than about 0.01% by weight, such as in an amount greater than about 0.05% by weight, such as in an amount greater than about 0.1% by weight, such as in an amount greater than about 0.15% by weight, such as in an amount greater than about 0.2% by weight. The carbonaceous material is generally present in an amount less than about 2% by weight, such as in an amount less than about 1.5% by weight, such as in an amount less than about 0.8% by weight, such as in an amount less than about 0.5% by weight.

In addition to the carbonaceous material, the polymer composition of the present disclosure can also contain one or more other laser additives. In particular, one or more other laser additives can blend well with the carbonaceous material in order to dramatically enhance the transmission properties of the resulting composition. The one or more other laser additives, for instance, can comprise one or more pigments or dyes. In one particular application, for instance, the polymer composition can contain a laser additive that comprises a quinoline. In one aspect, for instance, the quinoline can be 3-hydroxy-2-methylquinolin-4(1H)-one. The quinoline can be present in the composition in relatively low amounts. For instance, the quinoline can be present in an amount from about 0.0001% by weight to about 0.5% by weight, such as from about 0.01% by weight to about 0.1% by weight.

In one embodiment, the polymer composition may contain reinforcing fibers. Reinforcing fibers of which use may advantageously be made are mineral fibers, such as glass fibers, polymer fibers, in particular organic high-modulus fibers, such as aramid fibers, or metal fibers, such as steel fibers, or carbon fibers or natural fibers, or fibers from renewable resources.

The fibers may be in modified or unmodified form, e.g. provided with a sizing, or chemically treated, in order to improve adhesion to the plastic. Glass fibers are particularly preferred.

Glass fibers can be provided with a sizing to protect the glass fiber, to smooth the fiber but also to improve the adhesion between the fiber and the matrix material. A sizing usually comprises silanes, film forming agents, lubricants, wetting agents, adhesive agents optionally antistatic agents and plasticizers, emulsifiers, and optionally further additives.

Specific examples of silanes are aminosilanes, e.g. 3-trimethoxysilylpropylamine, N-(2-aminoethyl)-3-aminopropyltrimethoxy-silane, N-(3-trimethoxysilanylpropyl)ethane-1,2-diamine, 3-(2-aminoethyl-amino)propyltrimethoxysilane, N-[3-(trimethoxysilyl)propyl]-1,2-ethane-diamine.

Film forming agents are for example polyvinylacetates, polyesters and polyurethanes. Sizings based on polyurethanes may be used advantageously.

The reinforcing fibers may be compounded into the polymer matrix, for example in an extruder or kneader.

According to one embodiment, the polymer composition of the present disclosure comprises at least one reinforcing fiber which is a mineral fiber, preferably a glass fiber, more preferably a coated or impregnated glass fiber. Glass fibers which are suitable for the molding composition of the present disclosure are commercially available, e.g. Johns Manville, ThermoFlow® Chopped Strand 753, OCV Chopped Strand 408 A, Nippon Electric Glass Co. (NEG) Chopped Strand T-651.

Fiber diameters can vary depending upon the particular fiber used and whether the fiber is in either a chopped or a continuous form. The fibers, for instance, can have a diameter of from about 5 μm to about 100 μm, such as from about 5 μm to about 50 μm, such as from about 5 μm to about 15 μm. The length of the fibers can vary depending upon the particular application. For instance, the fibers can have an average length of greater than about 100 microns, such as greater than about 200 microns, such as greater than about 300 microns, such as greater than about 350 microns. The length of the fibers can generally be less than about 1,000 microns, such as less than about 800 microns, such as less than about 600 microns, such as less than about 500 microns. Once incorporated into the polymer composition and molded into an article, the fiber length can decrease. For instance, the average fiber length in the final product can be from about 100 microns to about 400 microns, such as from about 100 microns to about 300 microns.

In one aspect, glass fibers are incorporated into the polymer composition that have a flat or ribbon-like shape. It was discovered that ribbon-like glass fibers produce low warpage properties. For example, the glass fibers can have a thickness to width ratio of greater than about 1:2, such as greater than about 1:4, such as greater than about 1:8, such as greater than about 1:12, and generally less than about 1:200, such as less than about 1:100.

Reinforcing fibers can be present in the polymer composition generally in an amount from about 12% to about 55% by weight, including all increments of 1% by weight therebetween. For example, reinforcing fibers, such as flat glass fibers, can be present in the polymer composition in an amount greater than about 15% by weight, such as in an amount greater than about 20% by weight, such as in an amount greater than about 25% by weight, such as in an amount greater than about 30% by weight. The reinforcing fibers are generally present in an amount less than about 48% by weight, such as in an amount less than about 42% by weight, such as in an amount less than about 38% by weight, such as in an amount less than about 34% by weight.

The polymer composition may also contain one or more lubricants. For instance, fatty acid esters may be present as lubricants. Fatty acid esters may be obtained by oxidative bleaching of a crude natural wax and subsequent esterification of the fatty acids with an alcohol. The alcohol typically has 1 to 4 hydroxyl groups and 2 to 20 carbon atoms. When the alcohol is multifunctional (e.g., 2 to 4 hydroxyl groups), a carbon atom number of 2 to 8 is particularly desired. Particularly suitable multifunctional alcohols may include dihydric alcohol (e.g., ethylene glycol, propylene glycol, butylene glycol, 1,3-propanediol, 1,4-butanediol, 1,6-hexanediol and 1,4-cyclohexanediol), trihydric alcohol (e.g., glycerol and trimethylolpropane), tetrahydric alcohols (e.g., pentaerythritol and erythritol), and so forth. Aromatic alcohols may also be suitable, such as o-, m- and p-tolylcarbinol, chlorobenzyl alcohol, bromobenzyl alcohol, 2,4-dimethylbenzyl alcohol, 3,5-dimethylbenzyl alcohol, 2,3,5-cumobenzyl alcohol, 3,4,5-trimethylbenzyl alcohol, p-cuminyl alcohol, 1,2-phthalyl alcohol, 1,3-bis(hydroxymethyl)benzene, 1,4-bis(hydroxymethyl)benzene, pseudocumenyl glycol, mesitylene glycol and mesitylene glycerol. Particularly suitable fatty acid esters for use in the present invention are derived from montanic waxes. For instance, montanic acids can be partially esterified with butylene glycol and montanic acids can be partially saponified with calcium hydroxide. In one aspect, the lubricant can be an ester of a montanic acid in combination with a polyol.

In one aspect, the lubricant can contain a mixture of montanic acid esters and calcium montanate. Other montanic acid esters that may be employed include montanic esters obtained as secondary products from the oxidative refining of raw montan wax. The lubricant can contain montanic acids esterified with ethylene glycol or glycerine.

Other known waxes may also be employed as a lubricant. Amide waxes, for instance, may be employed that are formed by reaction of a fatty acid with a monoamine or diamine (e.g., ethylenediamine) having 2 to 18, especially 2 to 8, carbon atoms. For example, ethylenebisamide wax, which is formed by the amidization reaction of ethylene diamine and a fatty acid, may be employed. The fatty acid may be in the range from C₁₂ to C₃₀, such as from stearic acid (C₁₈ fatty acid) to form ethylenebisstearamide wax. Ethylenebisstearamide wax is commercially available from Lonza, Inc. under the designation Acrawax® C, which has a discrete melt temperature of 142° C. Other ethylenebisamides include the bisamides formed from lauric acid, palmitic acid, oleic acid, linoleic acid, linolenic acid, oleostearic acid, myristic acid and undecalinic acid. Still other suitable amide waxes are N-(2-hydroxyethyl)12-hydroxystearamide and N,N′-(ethylene bis)12-hydroxystearamide, which are commercially available from CasChem, a division of Rutherford Chemicals LLC, under the designations Paricin® 220 and Paricin® 285, respectively.

One or more lubricants can be present in the polymer composition generally in an amount greater than about 0.1% by weight, such as in an amount greater than about 0.2% by weight, such as in an amount greater than about 0.8% by weight, such as in an amount greater than about 1% by weight. One or more lubricants are generally present in an amount less than about 5% by weight, such as in an amount less than about 4% by weight, such as in an amount less than about 3.5% by weight.

The polymer composition of the present disclosure can contain various other additives. For example, the polymer composition may contain at least one stabilizer. The stabilizer may comprise an antioxidant, a light stabilizer such as an ultraviolet light stabilizer, a thermal stabilizer, and the like.

Sterically hindered phenolic antioxidant(s) may be employed in the composition. Examples of such phenolic antioxidants include, for instance, calcium bis(ethyl 3,5-di-tert-butyl-4-hydroxybenzylphosphonate) (Irganox® 1425); terephthalic acid, 1,4-dithio-,S,S-bis(4-tert-butyl-3-hydroxy-2,6-dimethylbenzyl) ester (Cyanox® 1729); triethylene glycol bis(3-tert-butyl-4-hydroxy-5-methylhydrocinnamate); hexamethylene bis(3,5-di-tert-butyl-4-hydroxyhydrocinnamate (Irganox® 259); 1,2-bis(3,5,di-tert-butyl-4-hydroxyhydrocinnamoyl)hydrazide (Irganox® 1024); 4,4′-di-tert-octyldiphenamine (Naugalube® 438R); phosphonic acid, (3,5-di-tert-butyl-4-hydroxybenzyl)-,dioctadecyl ester (Irganox® 1093); 1,3,5-trimethyl-2,4,6-tris(3′,5′-di-tert-butyl-4′ hydroxybenzyl)benzene (Irganox® 1330); 2,4-bis(octylthio)-6-(4-hydroxy-3,5-di-tert-butylanilino)-1,3,5-triazine (Irganox® 565); isooctyl 3-(3,5-di-tert-butyl-4-hydroxyphenyl)propionate (Irganox® 1135); octadecyl 3-(3,5-di-tert-butyl-4-hydroxyphenyl)propionate (Irganox® 1076); 3,7-bis(1,1,3,3-tetramethylbutyl)-10H-phenothiazine (Irganox® LO 3); 2,2′-methylenebis(4-methyl-6-tert-butylphenol)monoacrylate (Irganox® 3052); 2-tert-butyl-6-[1-(3-tert-butyl-2-hydroxy-5-methylphenyl)ethyl]-4-methylphenyl acrylate (Sumilizer® TM 4039); 2-[1-(2-hydroxy-3,5-di-tert-pentylphenyl)ethyl]-4,6-di-tert-pentylphenyl acrylate (Sumilizer® GS); 1,3-dihydro-2H-Benzimidazole (Sumilizer® MB); 2-methyl-4,6-bis[(octylthio)methyl]phenol (Irganox® 1520); N,N′-trimethylenebis-[3-(3,5-di-tert-butyl-4-hydroxyphenyl)propionamide (Irganox® 1019); 4-n-octadecyloxy-2,6-diphenylphenol (Irganox® 1063); 2,2′-ethylidenebis[4,6-di-tert-butylphenol] (Irganox® 129); N N′-hexamethylenebis(3,5-di-tert-butyl-4-hydroxyhydrocinnamamide) (Irganox® 1098); diethyl (3,5-di-tert-butyl-4-hydroxybenxyl)phosphonate (Irganox® 1222); 4,4′-di-tert-octyldiphenylamine (Irganox® 5057); N-phenyl-1-napthalenamine (Irganox® L 05); tris[2-tert-butyl-4-(3-ter-butyl-4-hydroxy-6-methylphenylthio)-5-methyl phenyl]phosphite (Hostanox® OSP 1); zinc dinonyidithiocarbamate (Hostanox® VP-ZNCS 1); 3,9-bis[1,1-diimethyl-2-[(3-tert-butyl-4-hydroxy-5-methylphenyl)propionyloxy]ethyl]-2,4,8,10-tetraoxaspiro[5.5]undecane (Sumilizer® AG80); pentaerythrityl tetrakis[3-(3,5-di-tert-butyl-4-hydroxyphenyl)propionate] (Irganox® 1010); ethylene-bis(oxyethylene)bis[3-(5-tert-butyl-4-hydroxy-m-tolyl)-propionate (Irganox® 245); 3,5-di-tert-butyl-4-hydroxytoluene (Lowinox BHT, Chemtura) and so forth.

Some examples of suitable sterically hindered phenolic antioxidants for use in the present corn position are triazine antioxidants having the following general formula:

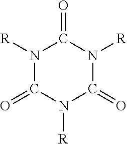

wherein, each R is independently a phenolic group, which may be attached to the triazine ring via a C₁ to C₅ alkyl or an ester substituent. Preferably, each R is one of the following formula (I)-(III):

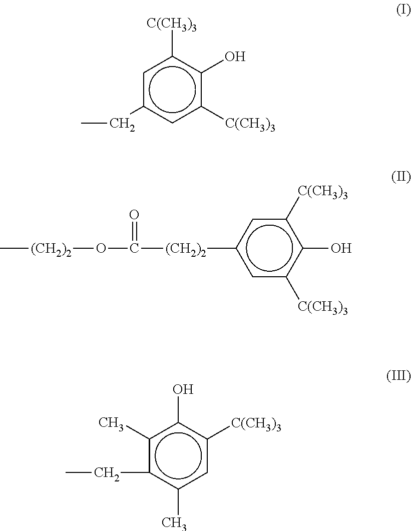

Commercially available examples of such triazine-based antioxidants may be obtained from American Cyanamid under the designation Cyanox® 1790 (wherein each R group is represented by the Formula III) and from Ciba Specialty Chemicals under the designations Irganox® 3114 (wherein each R group is represented by the Formula I) and Irganox® 3125 (wherein each R group is represented by the Formula II).

Sterically hindered phenolic antioxidants may constitute from about 0.01 wt. % to about 3 wt. %, in some embodiments from about 0.05 wt. % to about 1 wt. %, and in some embodiments, from about 0.05 wt. % to about 0.1 wt. % of the entire stabilized polymer composition. In one embodiment, for instance, the antioxidant comprises pentaerythrityl tetrakis[3-(3,5-di-tert-butyl-4-hydroxyphenyl)propionate.

Hindered amine light stabilizers (“HALS”) may be employed in the composition to inhibit degradation of the polyester composition and thus extend its durability. Suitable HALS compounds may be derived from a substituted piperidine, such as alkyl-substituted piperidyl, piperidinyl, piperazinone, alkoxypiperidinyl compounds, and so forth. For example, the hindered amine may be derived from a 2,2,6,6-tetraalkylpiperidinyl. Regardless of the compound from which it is derived, the hindered amine is typically an oligomeric or polymeric compound having a number average molecular weight of about 1,000 or more, in some embodiments from about 1000 to about 20,000, in some embodiments from about 1500 to about 15,000, and in some embodiments, from about 2000 to about 5000. Such compounds typically contain at least one 2,2,6,6-tetraalkylpiperidinyl group (e.g., 1 to 4) per polymer repeating unit.

Without intending to be limited by theory, it is believed that high molecular weight hindered amines are relatively thermostable and thus able to inhibit light degradation even after being subjected to extrusion conditions. One particularly suitable high molecular weight hindered amine has the following general structure:

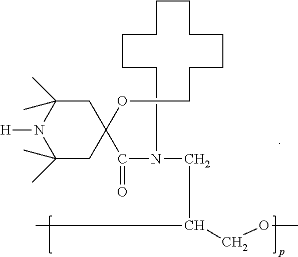

wherein, p is 4 to 30, in some embodiments 4 to 20, and in some embodiments 4 to 10. This oligomeric compound is commercially available from Clariant under the designation Hostavin® N30 and has a number average molecular weight of 1200.

Another suitable high molecular weight hindered amine has the following structure:

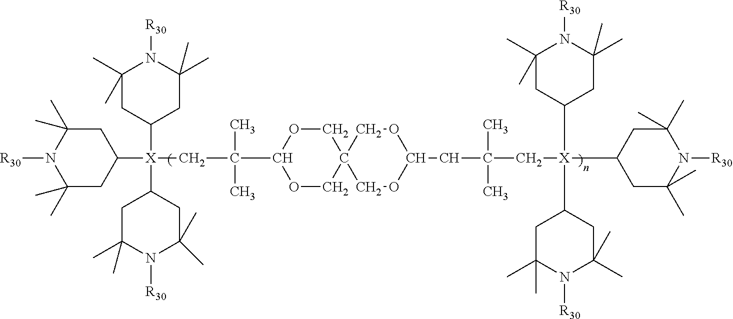

wherein, n is from 1 to 4 and R₃₀ is independently hydrogen or CH₃. Such oligomeric compounds are commercially available from Adeka Palmarole SAS (joint venture between Adeka Corp. and Palmarole Group) under the designation ADK STAB® LA-63 (R₃₀ is CH₃) and ADK STAB® LA-68 (R₃₀ is hydrogen).

Other examples of suitable high molecular weight hindered amines include, for instance, an oligomer of N-(2-hydroxyethyl)-2,2,6,6-tetramethyl-4-piperidinol and succinic acid (Tinuvin® 622 from Ciba Specialty Chemicals, MW=4000); oligomer of cyanuric acid and N,N-di(2,2,6,6-tetramethyl-4-piperidyl)-hexamethylene diamine; poly((6-morpholine-S-triazine-2,4-diyl)(2,2,6,6-tetramethyl-4-piperidinyl)-iminohexamethylene-(2,2,6,6-tetramethyl-4-piperidinyl)-imino) (Cyasorb® UV 3346 from Cytec, MW=1600); polymethylpropyl-3-oxy-[4(2,2,6,6-tetramethyl)-piperidinylysiloxane (Uvasil® 299 from Great Lakes Chemical, MW=1100 to 2500); copolymer of α-methylstyrene-N-(2,2,6,6-tetramethyl-4-piperidinyl)maleimide and N-stearyl maleimide; 2,4,8,10-tetraoxaspiro[5.5]undecane-3,9-diethanol tetramethyl-polymer with 1,2,3,4-butanetetracarboxylic acid; and so forth. Still other suitable high molecular weight hindered amines are described in U.S. Pat. No. 5,679,733 to Malik, et al. and U.S. Pat. No. 6,414,155 to Sassi, et al., which are incorporated herein in their entirety by reference thereto for all purposes.

In addition to the high molecular hindered amines, low molecular weight hindered amines may also be employed in the composition. Such hindered amines are generally monomeric in nature and have a molecular weight of about 1000 or less, in some embodiments from about 155 to about 800, and in some embodiments, from about 300 to about 800.

Specific examples of such low molecular weight hindered amines may include, for instance, bis-(2,2,6,6-tetramethyl-4-piperidyl) sebacate (Tinuvin® 770 from Ciba Specialty Chemicals, MW=481); bis-(1,2,2,6,6-pentamethyl-4-piperidinyl)-(3,5-ditert.butyl-4-hydroxybenzyl)butyl-propane dioate; bis-(1,2,2,6,6-pentamethyl-4-piperidinyl)sebacate; 8-acetyl-3-dodecyl-7,7,9,9-tetramethyl-1,3,8-triazaspiro-(4,5)-decane-2,4-dione, butanedioic acid-bis-(2,2,6,6-tetramethyl-4-piperidinyl) ester; tetrakis-(2,2,6,6-tetramethyl-4-piperidyl)-1,2,3,4-butane tetracarboxylate; 7-oxa-3,20-diazadispiro(5.1.11.2) heneicosan-20-propanoic acid, 2,2,4,4-tetramethyl-21-oxo, dodecyl ester; N-(2,2,6,6-tetramethyl-4-piperidinyl)-N′-amino-oxamide; o-t-amyl-o-(1,2,2,6,6-pentamethyl-4-piperidinyl)-monoperoxi-carbonate; β-alanine, N-(2,2,6,6-tetramethyl-4-piperidinyl), dodecylester; ethanediamide, N-(1-acetyl-2,2,6,6-tetramethylpiperidinyl)-N′-dodecyl; 3-dodecyl-1-(2,2,6,6-tetramethyl-4-piperidinyl)-pyrrolidin-2,5-dione; 3-dodecyl-1-(1,2,2,6,6-pentamethyl-4-piperidinyl)-pyrrolidin-2,5-dione; 3-dodecyl-1-(1-acetyl,2,2,6,6-tetramethyl-4-piperidinyl)-pyrrolidin-2,5-dione, (Sanduvar® 3058 from Clariant, MW=448.7); 4-benzoyloxy-2,2,6,6-tetramethylpiperidine; 1-[2-(3,5-di-tert-butyl-4-hydroxyphenylpropionyloxy)ethyl]-4-(3,5-di-tert-butyl-4-hydroxylphenyl propionyloxy)-2,2,6,6-tetramethyl-piperidine; 2-methyl-2-(2″,2″,6″,6″-tetramethyl-4″-piperidinylamino)-N-(2′,2′,6′,6′-tetra-methyl-4′-piperidinyl)propionylamide; 1,2-bis-(3,3,5,5-tetramethyl-2-oxo-piperazinyl)ethane; 4-oleoyloxy-2,2,6,6-tetramethylpiperidine; and combinations thereof. Other suitable low molecular weight hindered amines are described in U.S. Pat. No. 5,679,733 to Malik, et al.

The hindered amines may be employed singularly or in combination in any amount to achieve the desired properties, but typically constitute from about 0.01 wt. % to about 4 wt. % of the polymer composition.

UV absorbers, such as benzotriazoles or benzopheones, may be employed in the composition to absorb ultraviolet light energy. Suitable benzotriazoles may include, for instance, 2-(2-hydroxyphenyl)benzotriazoles, such as 2-(2-hydroxy-5-methylphenyl)benzotriazole; 2-(2-hydroxy-5-tert-octylphenyl)benzotriazole (Cyasorb® UV 5411 from Cytec); 2-(2-hydroxy-3,5-di-tert-butylphenyl)-5-chlorobenzo-triazole; 2-(2-hydroxy-3-tert-butyl-5-methylphenyl)-5-chlorobenzotriazole; 2-(2-hydroxy-3,5-dicumylphenyl)benzotriazole; 2,2′-methylenebis(4-tert-octyl-6-benzo-triazolylphenol); polyethylene glycol ester of 2-(2-hydroxy-3-tert-butyl-5-carboxyphenyl)benzotriazole; 2-[2-hydroxy-3-(2-acryloyloxyethyl)-5-methylphenyl]-benzotriazole; 2-[2-hydroxy-3-(2-methacryloyloxyethyl)-5-tert-butylphenyl]benzotriazole, 2-[2-hydroxy-3-(2-methacryloyloxyethyl)-5-tert-octylphenyl]benzotriazole; 2-[2-hydroxy-3-(2-methacryloyloxyethyl)-5-tert-butylphenyl]-5-chlorobenzotriazole; 2-[2-hydroxy-5-(2-methacryloyloxyethyl)phenyl]benzotriazole; 2-[2-hydroxy-3-tert-butyl-5-(2-methacryloyloxyethyl)phenyl]benzotriazole; 2-[2-hydroxy-3-tert-amyl-5-(2-methacryloyloxyethyl)phenyl]benzotriazole; 2-[2-hydroxy-3-tert-butyl-5-(3-methacryloyloxypropyl)phenyl]-5-chlorobenzotriazole; 2-[2-hydroxy-4-(2-methacryloyloxymethyl)phenyl]benzotriazole; 2-[2-hydroxy-4-(3-methacryloyloxy-2-hydroxypropyl)phenyl]benzotriazole; 2-[2-hydroxy-4-(3-methacryloyloxypropyl)phenyl]benzotriazole; and combinations thereof.

Exemplary benzophenone light stabilizers may likewise include 2-hydroxy-4-dodecyloxybenzophenone; 2,4-dihydroxybenzophenone; 2-(4-benzoyl-3-hydroxyphenoxy)ethyl acrylate (Cyasorb® UV 209 from Cytec); 2-hydroxy-4-n-octyloxy)benzophenone (Cyasorb® 531 from Cytec); 2,2′-dihydroxy-4-(octyloxy)benzophenone (Cyasorb® UV 314 from Cytec); hexadecyl-3,5-bis-tert-butyl-4-hydroxybenzoate (Cyasorb® UV 2908 from Cytec); 2,2′-thiobis(4-tert-octylphenolato)-n-butylamine nickel(II) (Cyasorb® UV 1084 from Cytec); 3,5-di-tert-butyl-4-hydroxybenzoic acid, (2,4-di-tert-butylphenyl)ester (Cyasorb® 712 from Cytec); 4,4′-dimethoxy-2,2′-dihydroxybenzophenone (Cyasorb® UV 12 from Cytec); and combinations thereof.

When employed, UV absorbers may constitute from about 0.01 wt. % to about 4 wt. % of the entire polymer composition.

Once formed, the polymer composition may be molded into a shaped part for use in a wide variety of different applications. For example, the shaped part may be molded using an injection molding process in which dried and preheated plastic granules are injected into the mold.

The polymer composition and/or shaped molded part can be used in a variety of applications. For example, the molded part can be employed in lighting assemblies, battery systems, sensors and electronic components, portable electronic devices such as smart phones, MP3 players, mobile phones, computers, televisions, automotive parts, etc. In one particular embodiment, the molded part may be employed in a camera module, such as those commonly employed in wireless communication devices (e.g., cellular telephone). For example, the camera module may employ a base, carrier assembly mounted on the base, a cover mounted on the carrier assembly, etc. The base may have a thickness of about 500 micrometers or less, in some embodiments from about 10 to about 450 micrometers, and in some embodiments, from about 20 to about 400 micrometers. Likewise, the carrier assembly may have a wall thickness of about 500 micrometers or less, in some embodiments from about 10 to about 450 micrometers, and in some embodiments, from about 20 to about 400 micrometers.

In one aspect, the polymer composition of the present disclosure can be used to produce a housing for electronic devices. For instance, the polymer composition can be a housing for a sensor. In one particular embodiment, the sensor can be part of an advanced driver assistance system.

As described above, polymer articles made according to the present disclosure are laser weldable and not only have high light transmission properties but also have uniform transmission properties. Consequently, the articles are well suited for use in laser weldable methods. During laser welding, for instance, a molded article can be contacted with a laser beam. The laser beam causes a localized temperature increase within the polymer composition used to form the molded article. The polymer composition increases in temperature to an amount sufficient to flow and form a weld. The laser beam, for instance, can operate at a wavelength of light of greater than about 400 nm, such as greater than about 600 nm, such as greater than about 800 nm, and generally less than about 2000 nm, such as less than about 1500 nm, such as less than about 1200 nm, such as less than about 1050 nm.

The present disclosure may be better understood with reference to the following examples.

### EXAMPLES

A polymer composition was formulated in accordance with the present disclosure and tested for various properties.

More particularly, the following formulation was tested:

| Component | Wt. % |
|---|---|
| First polybutylene terephthalate | 21.75 |
| polymer (0.75 dl/gr intrinsic viscosity) | |
| Second polybutylene terephthalate | 23 |
| polymer (1.3 dl/gr intrinsic viscosity) | |
| Polyethylene terephthalate polymer | 23 |
| Flat glass fibers | 30 |
| Ester of montanic acids combined with | 0.25 |
| a polyol | |
| Masterbatch of polybutylene | 2 |
| terephthalate polymer combined with | |
| carbon black | |

The above formulation was molded into test plaques and the following results were obtained. More particularly, two different samples were produced and tested.

| Test | Unit | Method | Sample 1 | Sample 2 |
|---|---|---|---|---|
| Density | g/cm3 | ISO1183 | | 1.5539 |
| MVR | cm3/10 min | 265 C., 2.16 kg | 16.9 | 16.7 |
| Tensile Modulus | MPa | ISO527-2/1A | 10608 | 10203 |
| Tensile Stress | MPa | ISO527-2/1A | 149.13 | 146.24 |
| at break, 5 mm/min | | | | |
| Tensile Strain | % | ISO527-2/1A | 2.38 | 2.37 |
| at break, 5 mm/min | | | | |
| Charpy unnotched | KJ/m2 | ISO179/1eU | | 55.7 |
| impact strength 23 C. | | | | |
| Charpy unnotched | KJ/m2 | ISO179/1eU | | 51 |
| impact strength −30 C. | | | | |
| Charpy notched | KJ/m2 | ISO179/1eA | 11.4 | 10.7 |
| impact strength 23 C. | | | | |
| Charpy notched | KJ/m2 | ISO179/1eA | | 10.2 |
| impact strength −30 C. | | | | |
| Flexural strength | MPa | ISO 178 | 232 | 228 |
| Flexural Modulus | MPa | ISO 178 | 10388 | 10200 |
| Transmission data | % (980 nm) | | 16-66 | 53-69 |
| (1 mm thickness) | | | | |
| Color CIE L | | | | 29.76 |
| Color CIE a | | | | −0.58 |
| Color CIE b | | | | −1.43 |

Laser transmission in the above table was measured at a wavelength of 980 nm using a spectrophotometer. Any suitable spectrophotometer may be used including a V570 spectrophotometer manufactured by Jasco.

As shown above, each sample was tested twice for transmission. One test was conducted near where the gate was located on the injection molding system and the other measurement was taken a distance from the gate. The first sample was injection molded at a temperature of 260° C. and at a mold temperature of 85° C. As shown, the transmission varied between the two locations. The second sample, on the other hand, was molded at a temperature of 280° C. and at a mold temperature of 100° C. In the second sample, the transmission properties of the molded article was much more uniform.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A laser weldable composition comprising:
a polymer composition comprising a mixture of a first polyester polymer and a second polyester polymer, the first polyester polymer having a different crystallization rate than the second polyester polymer, the polymer composition further comprising reinforcing fibers and a laser additive, the reinforcing fibers being present in the polymer composition in an amount from about 12% to about 42% by weight, the laser additive comprising a masterbatch containing a laser additive combined with a carrier polymer, the laser additive comprising a carbonaceous material.

2. A laser weldable composition as defined in claim 1, wherein the polymer composition further comprises a lubricant.

3. A laser weldable composition as defined in claim 2, wherein the lubricant comprises an ester of one or more carboxylic acids.

4. A laser weldable composition as defined in claim 2, wherein the lubricant is present in the polymer composition in an amount from about 0.05% by weight to about 4.8% by weight, the lubricant comprising an ester of a montanic acid, the lubricant further comprising a polyol.

5. A laser weldable composition as defined in claim 1, wherein the first polyester polymer comprises a polybutylene terephthalate polymer.

6. A laser weldable composition as defined in claim 1, wherein the second polyester polymer comprises a polyethylene terephthalate polymer.

7. A laser weldable composition as defined in claim 1, wherein the first polyester polymer is present in the composition in an amount from about 30% by weight to about 60% by weight, the second polyester polymer being present in the polymer composition in an amount from about 12% by weight to about 30% by weight.

8. A laser weldable composition as defined in claim 1, wherein the reinforcing fibers comprise glass fibers.

9. A laser weldable composition as defined in claim 8, wherein the reinforcing fibers are present in the polymer composition in an amount from about 25% by weight to about 38% by weight.

10. A laser weldable composition as defined in claim 1, wherein the carbonaceous material comprises carbon black particles.

11. A laser weldable composition as defined in claim 1, wherein the carbonaceous material is present in the polymer composition in an amount from about 0.1% by weight to about 0.8% by weight.

12. A laser weldable composition as defined in claim 1, wherein the carrier polymer contained in the masterbatch comprises a copolyester.

13. A laser weldable composition as defined in claim 1, wherein the carbonaceous material has an intrinsic thermal conductivity of about 40 W/m-K or more.

14. A laser weldable composition as defined in claim 1, wherein the composition contains a second laser additive comprising a quinoline.

15. A laser weldable composition as defined in claim 1, wherein the polymer composition displays a transmission at a wavelength of 980 nm and at a thickness of 1 mm of greater than about 50%, and less than about 95%.

16. A molded article formed from the polymer composition as defined in claim 1.

17. An assembly including the molded article as defined in claim 16, the molded article having been laser welded to an adjacent component.

18. A sensor comprising a housing, the housing being made from the polymer composition as defined in claim 1.

19. An advanced driver assistance system including the sensor as defined in claim 18.

20. A method for attaching a polymer article to an adjacent surface comprising:
contacting a molded article made from the laser weldable composition as defined in claim 1 with a laser beam, the laser beam causing a localized temperature increase within the polymer composition sufficient for the polymer composition to flow and form a weld.
